(19) United States
(12) Patent Application Publication
(10) Pub. No.: US 2026/0028546 A1
(43) Pub. Date: Jan. 29, 2026

(54) STRIPPING VAPOR CONDENSATE RECOVERY UNIT

(71) Applicant: ConocoPhillips Company, Houston, TX (US)

(72) Inventors: Travis DINSDALE, Houston, TX (US); Michael A. D'IPPOLITO, Houston, TX (US); James KADAR, Houston, TX (US); Stephen JACKSON, Nisku (CA); Anton VINOKUROV, Houston, TX (US)

(21) Appl. No.: 19/282,271

(22) Filed: Jul. 28, 2025

Related U.S. Application Data
(60) Provisional application No. 63/675,819, filed on Jul. 26, 2024.

(51) Int. Cl. C10L 3/10; B01D 3/34

(52) U.S. Cl. CPC C10L 3/101; B01D 3/346

(57) ABSTRACT

Disclosed are systems and methods for improving condensate recovery. A first stripping vapor is injected into a condensate fractionator tower. Introducing the first stripping vapor into the condensate fractionator tower allows for an operating temperature of the condensate fractionator tower to be decrease while achieve a required condensate recovery rate. The condensate fractionator tower further separates a condensate product from a light oil product and directs the condensate product and light oil product to storage.

### CROSS-REFERENCE TO RELATED APPLICATIONS

The present application claims priority to U.S. Provisional Patent Application No. 63/675,819 filed on Jul. 26, 2024, which is incorporated by reference in its entirety herein.

### TECHNICAL FIELD

Aspects of the present disclosure relate generally to systems and methods for collection of natural gas and more particularly to condensate recovery during the collection process.

### BACKGROUND

Natural gas is a commonly used resource comprised of a mixture of naturally occurring hydrocarbon gases typically found in deep underground natural rock formations or other hydrocarbon reservoirs. More particularly, natural gas is primarily comprised of methane and often includes other components, such as, ethane, propane, butane, pentane, carbon dioxide, nitrogen, hydrogen sulfide, and/or the like.

In the process of producing petroleum from hydrocarbon reservoirs, petroleum is a complex mixture of hydrocarbons and a variety of products may be produced ranging from solids to gases including methane, natural gas, naphtha, light oil, oil, heavy oil, condensate, waxes, heavy oils, tars, bitumens, and the like. Hydrocarbons can be as simple as methane (CH4), but many produced fluids are mixtures of highly complex molecules of gases, liquids, and/or solids. The molecules can have the shape of chains, branching chains, rings or other structures. Produced hydrocarbons are divided into broad and overlapping classifications based on the products produced, average weight, range, and composition of the hydrocarbons.

Hydrocarbon condensate, often simply referred to as condensate, is a low-density mixture of hydrocarbon liquids that are present in natural gas. These liquids are typically extracted as a by-product during the production of natural gas and crude oil. Condensates are composed mainly of pentane and heavier components and form when the temperature and pressure of a hydrocarbon mixture drop below its dew point, causing the heavier hydrocarbons to condense out of the gaseous state into a liquid form. This phase change can occur naturally within reservoirs or during the extraction and processing of natural gas hydrocarbons.

Unfortunately, some “grey” hydrocarbon fractions may possess properties that fall between product specifications, whilst not meeting all criteria for any single product. These grey fraction products cannot readily be transported to petroleum markets due to noncompliance with product specifications. Because the grey fractions cannot readily enter the petroleum market, there is a risk the product may be “stranded.” A stranded product is one that is too expensive to transport as is but cannot enter standard and much less expensive transportation systems. A stranded product does not fall into a defined hydrocarbon quality specification. The stranded product leads to multiple inefficiencies that increase cost and risk. For example, transporting a stranded product by truck may cause exhaust and risk of spillage that would not be present if the product could be transported by pipeline. Likewise, if the product is too difficult to get into a hydrocarbon market, it may be considered waste and require disposal or reduced rate sale.

It is with these observations in mind, among others, that various aspects of the present disclosure were conceived and developed.

### BRIEF SUMMARY OF THE DISCLOSURE

In some aspects, the techniques described herein relate to a method for condensate recovery in a natural gas facility, the method including: injecting a stripping vapor into a condensate fractionator tower of the natural gas facility, wherein injecting the stripping vapor into the condensate fractionator tower allows for an operating temperature of the condensate fractionator tower to be decreased while achieving a required condensate recovery rate; separating, at the condensate fractionator tower, a condensate product from a light oil product; and directing the condensate product and the light oil product to storage.

In some aspects, the techniques described herein relate to a system including: a condensate fractionator tower; a stripping vapor injection system configured to inject a stripping vapor into the condensate fractionator tower, allowing for an operating temperature of the condensate fractionator tower to be decreased while achieving a required condensate recovery rate; a light oil storage to receive a light oil product produced by the system; and a condensate storage to receive a condensate produced by the system.

In some aspects, the techniques described herein relate to a system including: a stripping vapor injection system configured to inject at least one stripping vapor into a condensate fractionator tower, allowing for an operating temperature of the condensate fractionator tower to be decreased while achieving a required condensate recovery rate; a light oil storage to receive a light oil product produced by the system; and a condensate storage to receive a condensate produced by the system.

Other implementations are also described and recited herein. Further, while multiple implementations are disclosed, still other implementations of the presently disclosed technology will become apparent to those skilled in the art from the following detailed description.

### BRIEF DESCRIPTION OF THE DRAWINGS

The foregoing summary, as well as the following detailed description, will be better understood when read in conjunction with the appended drawings. For the purpose of illustration, there is shown in the drawings certain examples of the presently disclosed technology. It should be understood, however, that the presently disclosed technology is not limited to the precise examples and features shown. The presently disclosed technology is capable of modifications in various aspects, all without departing from the spirit and scope of the presently disclosed technology. Accordingly, the drawings and detailed description are to be regarded as illustrative in nature and not limiting. The accompanying drawings, which are incorporated in and constitute a part of this specification, illustrate implementations of apparatuses consistent with the presently disclosed technology and, together with the description, serves to explain advantages and principles consistent with the presently disclosed technology, in which:

FIG. 1 illustrates an overall system block flow diagram;

FIG. 2 illustrates an example Condensate Recovery Unit;

FIG. 3 illustrates another example Condensate Recovery Unit;

FIG. 4 illustrates example operations of a method for condensate recovery.

### DETAILED DESCRIPTION

The present disclosure involves systems and methods for condensate recovery, including an effective and cost-efficient manner to safely recover condensate. The process described herein is a combination of unit operations to produce an on-spec condensate product and heavier light oil product. This is made possible by placing the feed under pressure and heating it to the point that it can be vaporized and separated (flashed). Further refinement of the flashed liquid by partially vaporizing and fractionating in a low-pressure distillation column produces a heavy (in terms of density and/or viscosity) product from the bottom of the column, a lighter naphtha rich product from the column overhead. Condensed vapors from the distillation column overhead produce a low density, low viscosity naphtha rich diluent stream that can be blended with heavy stabilized condensate to produce an on-specification sales condensate. In summary, by treating a heavy (in terms of density and/or viscosity) stabilized condensate an on-specification condensate product and light oil residual product are created.

Accordingly, the presently disclosed technology enables the reliable, efficient, and safe recovery of condensate. Other advantages will be apparent from the present disclosure.

The condensate recovery process described herein may incorporate one or more of several types of heating/cooling systems and methods including, but not limited to, indirect heat exchange, vaporization, and/or expansion or pressure reduction. Indirect heat exchange, as used herein, refers to a process involving a hotter/cooler stream heating/cooling a substance without actual physical contact between the hotter/cooler stream and the substance to be heated/cooled. Specific examples of indirect heat exchange include, but are not limited to, heat exchange undergone in a shell-and-tube heat exchanger, a plate and frame heat exchanger, a brazed aluminum plate-fin heat exchanger, and an aerial cooler.

Note that for hydrocarbon nomenclature, C#represents a hydrocarbon having #carbons and at least #hydrogens. C5 would be a hydrocarbon having 5 carbons and at least 5 hydrogens. Typically, a C5 hydrocarbon would have 5 carbons and 12 hydrogens, but may have fewer hydrogens if there are double bonds or one or more rings in the structure. Although C2+ and C5+ mixtures typically have heavier hydrocarbons mixed in, they may also have some lighter hydrocarbons in the mixture. Just as any hydrocarbon represented above may have some contamination of lighter and heavier hydrocarbons, and unless specified as having a specific purity (i.e. about 95%, 90%, 80%, etc.), petroleum fractions are presumed to be a mixture of hydrocarbons.

In the description, phraseology and terminology are employed for the purpose of description and should not be regarded as limiting. For example, the use of a singular term, such as “a”, is not intended as limiting of the number of items. Also, the use of relational terms such as, but not limited to, “down” and “up” or “downstream” and “upstream”, are used in the description for clarity in specific reference to the figures and are not intended to limit the scope of the presently disclosed technology or the appended claims. Further, any one of the features of the presently disclosed technology may be used separately or in combination with any other feature. For example, references to the term “implementation” means that the feature or features being referred to are included in at least one aspect of the presently disclosed technology. Separate references to the term “implementation” in this description do not necessarily refer to the same implementation and are also not mutually exclusive unless so stated and/or except as will be readily apparent to those skilled in the art from the description. For example, a feature, structure, process, step, action, or the like described in one implementation may also be included in other implementations but is not necessarily included. Thus, the presently disclosed technology may include a variety of combinations and/or integrations of the implementations described herein. Additionally, all aspects of the presently disclosed technology as described herein are not essential for its practice.

Lastly, the terms “or” and “and/or” as used herein are to be interpreted as inclusive or meaning any one or any combination. Therefore, “A, B or C” or “A, B and/or C” mean any of the following: “A”; “B”; “C”; “A and B”; “A and C”; “B and C”; or “A, B and C.” An exception to this definition will occur only when a combination of elements, functions, steps or acts are in some way inherently mutually exclusive.

Table 1 includes basic definitions of gas (dry or wet), lift (fuel) gas, natural gas liquids, sales condensate, light oil, light crude oil, and sour crude. Each of these products may be defined by a specification, primary hydrocarbons (C#), density (API gravity), viscosity, sulfur content, and other relevant product parameters. The specification ranges provided in Table 1 are approximations, and are not intended to be limiting, but rather to provide additional detail as to the natural gas products described herein.

TABLE 1

| | | | | API | | Other major |
|---|---|---|---|---|---|---|
| Product | ~C# | Density | Viscosity | Gravity | Sulfur | specifications |
| Gas (dry) | C1+ | — | — | — | <4-12 ppmv | Gross heating |
| | | | | | of H2S | value <950- |
| | | | | | | 1050 BTU/scf |
| Gas (wet) | C1+ | — | — | — | — | — |
| Lift (fuel) Gas | C1+ | — | — | — | — | — |
| Natural Gas | C2-C5 | 530-679 | — | 77-135°API | <10-350 | Vapor |
| Liquids | | kg/m³ @ | | | ppmw as S | pressure <1000 |
| (NGLs) | | 15° C. | | | | kPa at 37.8° C. |
| Sales | C4-C10 | 650-775 | <2.0 cSt @ | 51-86° API | <0.5 wt % | Vapor |
| Condensate | | kg/m³ @ | 7.5° C. | | | pressure <103 |
| | | 15° C. | | | | kPa at 37.8° C. |
| Sweet Light | C5-C18 | 799-876 | <20 cSt @ | 30-45° API | <0.5 wt % | Vapor |
| Oil (Sweet | | kg/m³ @ | 10.0° C. | | | pressure <95 |
| Crude, Light | | 15° C. | | | | kPa at 37.8° C. |
| Crude Oil) | | | | | | |
| Sour Light Oil | C5-C18 | 799-876 | <20 cSt @ | 30-45°API | >0.5 wt % | Vapor |
| (Sour Crude, | | kg/m³ @ | 10.0° C. | | | pressure <95 |
| Sour Light | | 15° C. | | | | kPa at 37.8° C. |
| Crude Oil) | | | | | | |

Quality specifications differ from pipeline to pipeline and have evolved over time due to impacts including varying supply sources, operational constraints and end user requirements. As such, the non-uniformity of pipeline requirements and changing use requirements may change sales specifications for differing products. Quality specifications are exemplified by Specification sheets such as the West Texas Intermediate (WTI), Brent, and Dubai Crude defined by API gravity, viscosity, and sulfur content.

Some fractions are characterized by carbon content with C#representing the predominant carbon fraction but often contain a mix with higher and lower carbon molecules included with the fraction. Dry gas for example can be called C1+ because it contains methane (CH4) as the predominant component but dry gas may contain approximately 90% C1, 5% C2, 2% C3, <1% C4, <1% C5+ along with nitrogen and carbon dioxide. Other specifications are also available for different pipelines, which may include terms including being free from sand, dust, gum, crude oil, contaminants, impurities; a dew point below −10° C.; less than 23 milligram H2S per cubic meter, less than 115 mg total sulfur per cubic meter; less than 2% by volume CO2; less 65 milligrams water per cubic meter; less than 49° C., free of oxygen; and the like. These requirements may change dependent on the pipeline operator, location, and end use. Wet gas would also be a C1+ because it contains mostly methane (CH4) but its composition is distinct from dry gas and it may contain approximately 65% C1, 12% C2, 9% C3, 4% C4, <1% C5+ along with nitrogen and carbon dioxide. Light Crude Oil may be characterized as C7+ but may contain a broad range of hydrocarbons such as propane (C3), butane (C4), pentane (C5), and hexane (C6) along with hydrocarbon chains larger than heptane (C7) in varying concentrations dependent upon the field, the producer, and any processing of the produced oil. Platts Specifications Guide for Americas Crude Oil (2024) contains a detailed list of varying oil sources and their compositions.

In some instances, natural gas liquids (NGL) and condensate terms are used interchangeably. NGLs and condensates both comprise a mixed stream of hydrocarbons representing light hydrocarbons, such as ethane, and heavier hydrocarbons, such as pentane. Natural gas liquids are composed of primarily natural gas liquids as well as some naphtha material.

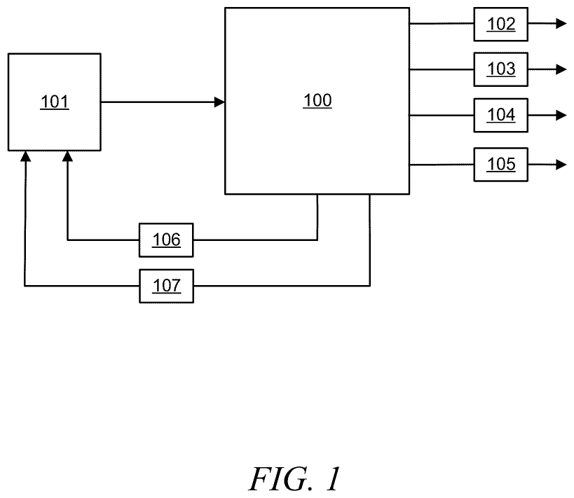

To begin the detailed description, a processing facility 100 is shown in FIG. 1. The processing facility 100 is a gas plant which processes effluent stream from wellpads 101, and, in turn, outputs sales products including, but not limited to a gas product 102, a natural gas liquid (NGL) product 103, a sales condensate product 104, a light oil product 105, a lift gas product (also referred to as a fuel gas product) 106 and frac water 107.

The processing facility 100 further includes a Condensate Recovery Unit (CRU). The purpose of the CRU is to make salable products, for example, a sales condensate and a light oil product. Through the fractionation process higher viscosity wax components are concentrated into the light oil fraction. Two streams are produced and the primary product is sales condensate. The CRU has the ability to preference one product over another. For example, in one instance, the CRU maximizes higher value sales condensate product.

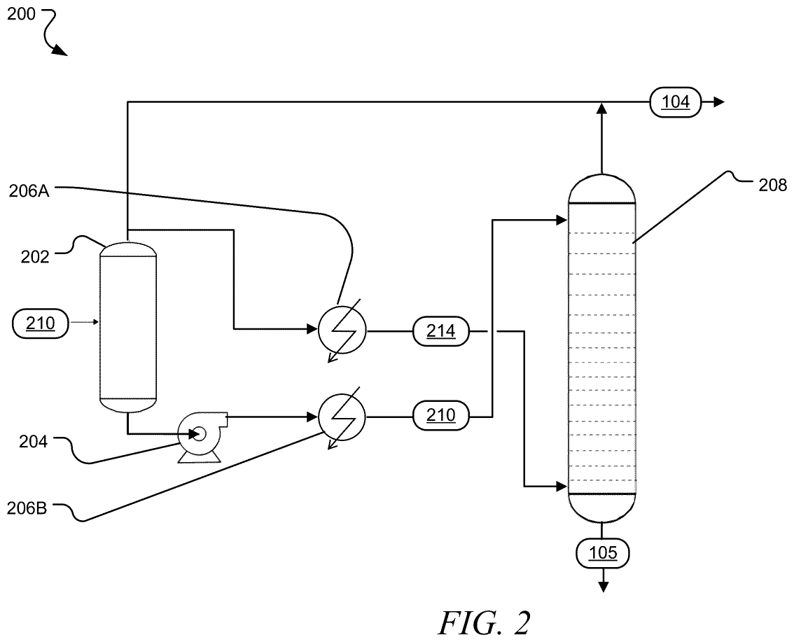

FIG. 2 provides an overview of an example condensate recovery system 200. The condensate recovery system 200 may be included within the processing facility 100 (shown in FIG. 1). The condensate recovery system 200 includes a pre flash drum 202, a pre flash drum pump 204, heater packages 206A, 206B (direct or indirect heaters), and a condensate fractionator tower 208. The condensate recovery system 200 may be deployed in the facility 100, for example, to generate the sales condensate product 104 and the light oil product 105. In some embodiments, there may be differences in the equipment employed to implement the process following.

A feed condensate 210 is fed into the pre flash drum 202. In the pre flash drum 202, at least a portion of the sales condensate product 104 can be extracted and eventually directed to a condensate storage (not shown). Another portion of the sales condensate product 104 (in the form of pre flash drum vapor) is routed through the heater package 206A, where the pre flash drum vapor is further heated by the heater package 206A to heat the pre flash drum vapor to a required temperature to be used as a stripping vapor 214. In some examples, the required temperature of the pre flash drum 202 is approximately 200° C. Overall condensate recoveries are maximized by introducing as much heat into the system as is feasible, while keeping the temperatures sufficiently below the autoignition temperature. The pressure in the pre flash drum 202 is controlled at a sufficiently high pressure to enable flashed vapor to flow via pressure control to the condensate fractionator tower 208.

The remaining feed condensate 210 is pumped to the heater package 206B by the pre flash drum pump 204. The pre flash drum pump 204 moves the bottom liquids located within the pre flash drum 202 to the condensate fractionator tower 208, as there is additional static head and higher pressure required to ensure the is no flashing. The heated feed condensate 210 is then routed into the condensate fractionator tower 208. In this example, the feed condensate 210 is fed into the condensate fractionator tower 208 near a top portion of the tower. The stripping vapor 214 is also routed into the condensate fractionator tower 208. In this example, the stripping vapor 214 is fed into the condensate fractionator tower 208 near a bottom portion of the tower.

The light oil product 105 collects at a bottom of the condensate fractionator tower 208. The light oil product 105 is pumped out of the condensate fractionator tower 208. In some instances the light oil product 105 is cooled and then C4 is blended into the light oil prior to being directed to product storage.

The addition of the stripping vapor 214 allows for a reduction of the operating temperature of the condensate fractionator tower 208 while achieving the required condensate recovery rates and meeting pipeline specifications requirements on condensate product density and viscosity. As the amount of stripping vapor 214 sent to the condensate fractionator tower 208 is increased, the temperature on the outlet of the inlet heaters 206A, 206B is lowered, and further, the temperature at the condensate fractionator tower 208 is lowered. Therefore, a temperature increase is not required to flash the condensate, rather, the stripping vapor 214 generates the mass transfer. In summary, there is a correlation between the amount of stripping vapor and the required fractionator operating temperature. The more stripping vapor the lower the required operating temperature of the fractionator tower to make sales products.

This provides a distinct benefit in reducing the operating temperature of the condensate recovery system 200. In some cases, the operating temperature may remain below the autoignition temperature, allowing for much safer operating conditions.

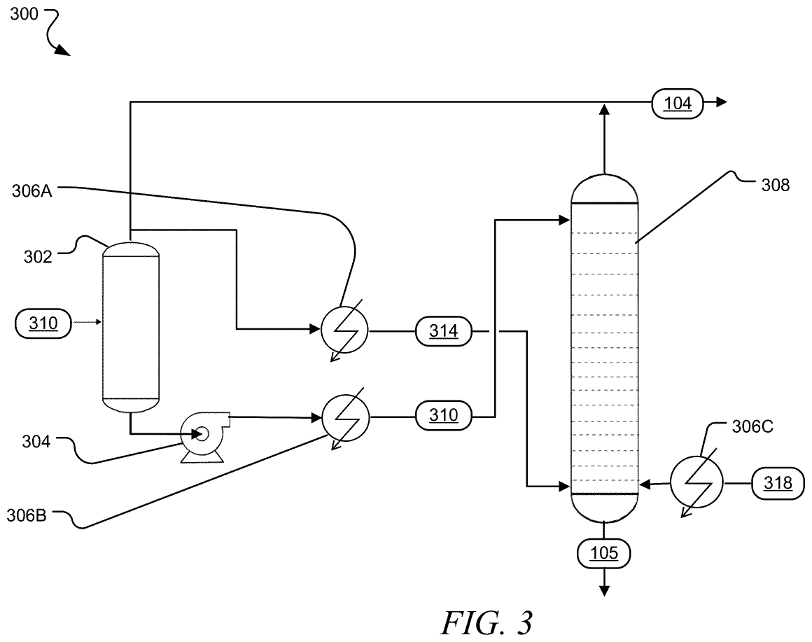

FIG. 3 provides an overview of another example condensate recovery system 300. The condensate recovery system 300 may be included within the processing facility 100 (shown in FIG. 1). Condensate recovery system 300 is substantially similar to condensate recovery system 200, with differences as described below. The condensate recovery system 300 includes a pre flash drum 302, a pre flash drum pump 304, heater packages 306A, 306B, 306C, and a condensate fractionator tower 308.

Similarly to condensate recovery system 200, in condensate recovery system 300, a feed condensate 310 is fed into the pre flash drum 302. In the pre flash drum 302, at least a portion of a sales condensate product 104 can be extracted and eventually directed to a condensate storage (not shown). A portion of the sales condensate product 104 is routed through the heater package 306A, which is further heated by the heater package 306A to heat a stripping vapor 314. The remaining feed condensate 310 is pumped to the heater package 306B by the pre flash drum pump 304. The feed condensate 310 is then routed into the condensate fractionator tower 308. In this example, the feed condensate 310 is fed into the condensate fractionator tower 308 near a top portion of the tower. The stripping vapor 314 is also routed into the condensate fractionator tower 308. In this example, the stripping vapor 314 is fed into the condensate fractionator tower 308 near a bottom portion of the tower. The light oil product 105 collects at a bottom of the condensate fractionator tower 308.

In this example, a second stripping vapor 318 may be routed from another source, for example, a debutanizer and heated by heater package 306C. In one example, the debutanizer extracts butane from the NGL (C3+) stream from the gas. The second stripping vapor 318 from the debutanizer may include C5+ (heavy hydrocarbons), C4 (butanes) and/or other hydrocarbons. The use of C5+ and C4 are ideal for use as stripping gas, as they are more effectively utilized to strip condensate, rather than using high temperatures to boil heavy components. In some instance, this allows the condensate recovery system 300 to operate at temperatures less than 200° C., which is considered below the autoignition temperature, significantly reducing the operational safety risks.

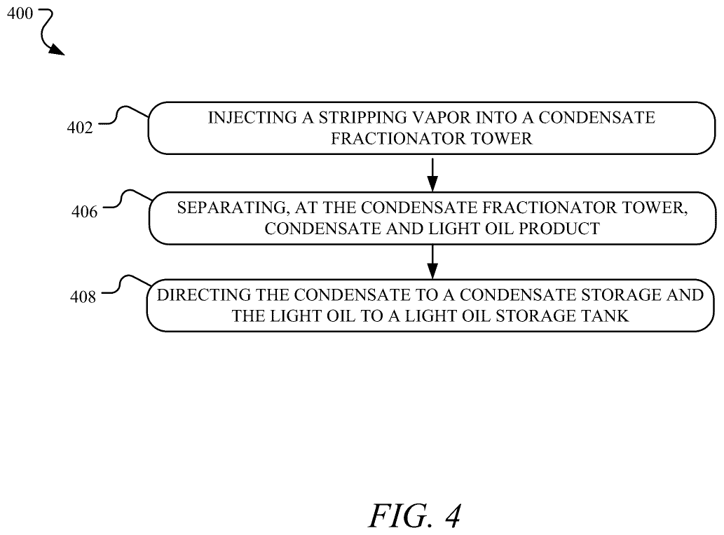

FIG. 4 illustrates example operations of a method 400 for condensate recovery, which may be performed by any of the systems discussed herein. In some instances, an operation 402 includes injecting a stripping vapor into a condensate fractionator tower of the natural gas facility. Introducing the stripping vapor into the condensate fractionator tower, allows for an operating temperature of the condensate fractionator tower to be decreased while achieving a required condensate recovery rate. In some examples, multiple streams and sources for stripping vapor may be used. An operation 406 includes separating, at the condensate fractionator tower, a condensate product from an oil product. And finally, operation 408 includes directing the condensate product to a condensate storage.

It is to be understood that the specific order or hierarchy of steps in the method depicted in FIG. 4 is an instance of an example approaches and can be rearranged while remaining within the disclosed subject matter. For instance, any of the steps depicted in FIG. 4 may be omitted, repeated, performed in parallel, performed in a different order, and/or combined with any other of the steps depicted in FIG. 4. Any accompanying method claims thus present elements of the various steps in a sample order and are not necessarily meant to be limited to the specific order or hierarchy presented unless explicitly stated.

Utilizing stripping vapor for condensate recovery unit allows for the system to meet specification and condensate recovery rates, while lowering pressure and maximizing the effectiveness of the stripping vapor. Further, the operation temperature is reduced below the autoignition temperature, leading to an overall safer design. The resulting system is less complex and does not require a direct fired heater, rather the system is able to utilize facility process heat medium and/or waste heat recovery units. Lower operating expenditure (OPEX) through reduced fuel consumption leads to lower greenhouse gas emissions. Further, the chlorine hydrolysis (acid formation) is reduced at the lower operating temperature, resulting in reduced corrosion rates and less complex corrosion control requirement.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A method for condensate recovery in a natural gas facility, the method comprising:
injecting a stripping vapor into a condensate fractionator tower of the natural gas facility, wherein injecting the stripping vapor into the condensate fractionator tower allows for an operating temperature of the condensate fractionator tower to be decreased while achieving a required condensate recovery rate;
separating, at the condensate fractionator tower, a condensate product from a light oil product; and
directing the condensate product and the light oil product to storage.

2. The method of claim 1, wherein the stripping vapor is a first stripping vapor, the method further comprising:
injecting a second stripping vapor into the condensate fractionator tower, wherein introducing the second stripping vapor into the condensate fractionator tower allows for the operating temperature of the condensate fractionator tower to be further decreased while achieving the required condensate recovery rate.

3. The method of claim 2, wherein the second stripping vapor is routed from a debutanizer.

4. The method of claim 2, wherein an introduction of at least one of the first stripping vapor or the second stripping vapor indicates a mass transfer resulting in the production of the condensate product.

5. The method of claim 1, wherein the stripping vapor is routed from a pre flash drum.

6. The method of claim 1, wherein the condensate product meets a pipeline specification requirement.

7. The method of claim 6, wherein the pipeline specification requirement includes a range relating to at least one of a density, a viscosity or an American Petroleum Institute (API) rating.

8. The method of claim 1, wherein the stripping vapor includes at least one of butane (C4) or heavy hydrocarbons (C5+).

9. The method of claim 1, wherein the operating temperature is reduced below an autoignition temperature.

10. A system comprising:
a condensate fractionator tower;
a stripping vapor injection system configured to inject a stripping vapor into the condensate fractionator tower, allowing for an operating temperature of the condensate fractionator tower to be decreased while achieving a required condensate recovery rate;
a light oil storage to receive a light oil product produced by the system; and
a condensate storage to receive a condensate produced by the system.

11. The system of claim 10, wherein the stripping vapor is a first stripping vapor, wherein the stripping vapor injection system injects a second stripping vapor into the condensate fractionator tower, wherein introducing the second stripping vapor into the condensate fractionator tower allows for the operating temperature of the condensate fractionator tower to be further decreased while achieving the required condensate recovery rate.

12. The system of claim 11, wherein the second stripping vapor is routed from a debutanizer.

13. The system of claim 11, wherein an introduction of at least one of the first stripping vapor or the second stripping vapor indicates a mass transfer resulting in the production of the condensate product.

14. The system of claim 10, wherein the stripping vapor is routed from a pre flash drum.

15. The system of claim 10, wherein the condensate product meets a pipeline specification requirement.

16. The system of claim 15, wherein the pipeline specification requirement includes a range relating to at least one of a density, a viscosity or an American Petroleum Institute (API) rating.

17. The system of claim 10, wherein the stripping vapor includes at least one of butane (C4) or heavy hydrocarbons (C5+).

18. The system of claim 10, wherein the operating temperature is reduced below an autoignition temperature.

19. A system comprising:
a stripping vapor injection system configured to inject at least one stripping vapor into a condensate fractionator tower, allowing for an operating temperature of the condensate fractionator tower to be decreased while achieving a required condensate recovery rate;
a light oil storage to receive a light oil product produced by the system; and
a condensate storage to receive a condensate produced by the system.

20. The system of claim 19, wherein the operating temperature is reduced below an autoignition temperature.
